(19) United States
(12) Patent Application Publication
(10) Pub. No.: US 2004/0190987 A1
(43) Pub. Date: Sep. 30, 2004

(54) Connecting apparatus for cubicle partitioning frames

(75) Inventor: Young-Il Yang, Seoul (KR)

Correspondence Address: MARGER JOHNSON & McCOLLOM, P.C., 1030 S.W. Morrison Street, Portland, OR, 97205, US

(73) Assignee: FURSYS INCORPORATION, Seoul (KR)

(21) Appl. No.: 10/650,218

(22) Filed: Aug. 27, 2003

(30) Foreign Application Priority Data
Aug. 30, 2002 (KR) P2002-51790

(51) Int. Cl. F16D 1/00

(52) U.S. Cl. 403/348; 403/408.1

(57) ABSTRACT

A connecting apparatus for cubicle partitioning frames is disclosed. The connecting apparatus for connecting neighboring partitioning frames each formed with connecting holes comprises a connecting plate formed at one end thereof with a first hitching jaw for insertion into and passing through the connecting hole and a second hitching jaw formed at the other end thereof for not passing through the connecting hole. The apparatus further comprises a leaf spring for being insertedly hitched by the first hitching jaw of the connecting plate, and a connector housing for pressing the leaf spring to be insertedly hitched by the first hitching jaw of the connecting plate. A slowly-rising-and-falling inclining hitching surface is formed inside the connector housing for pressing the leaf spring when hitched by the first hitching jaw to rotate the housing, and a hitching jaw is protrusively formed at the inclining hitching surface for restraining the rotation when the housing is rotated at a prescribed angle, such that the cubicle partitioning frames can be simply and sturdily assembled.

### FIELD OF THE INVENTION

The present invention relates to a connecting apparatus for cubicle partitioning frames.

### BACKGROUND OF THE INVENTION

In general, cubicles are configured to effectively utilize office space and enhance work efficiency of employees. Each cubicle is formed by connecting partitioning frames to plates, and each neighboring frame is connected by a connecting apparatus.

Conventional partitioning frames are respectively connected by bolts and nuts, or by bolts having a particular bolt head that match with a particular shape of a frame. Comer areas of a cubicle, which are connected at a prescribed angle, are connected by bolts via brackets or rectangular or other shapes of pillars to form a cubicle.

However, there are drawbacks in the conventional way of making cubicles by using bolts and nuts for connecting partitioning frames thus described in that the installation procedure for connecting the partitioning frames can be complicated, and although various connecting apparatuses have been proposed, the locking force of the connecting apparatuses remains weak.

### SUMMARY OF THE INVENTION

The present invention provides a simplified and sturdy configuration of a connecting apparatus for cubicle partitioning frames where the partitioning frames and corner parts are connected at a prescribed angle.

In accordance with an embodiment of the present invention, there is provided a connecting apparatus for cubicle partitioning frames, wherein each frame is formed with connecting holes. The connecting apparatus comprises a connecting plate formed at one end thereof with a first hitching jaw for insertion into and passing through the connecting hole and a second hitching jaw formed at the other end thereof for not passing through the connecting hole. The apparatus further comprises a leaf spring for being insertedly hitched by the first hitching jaw of the connecting plate, and a connector housing for pressing the leaf spring to be insertedly hitched by the first hitching jaw of the connecting plate. A slowly-rising-and-falling inclining hitching surface is formed inside the connector housing for pressing the leaf spring when hitched by the first hitching jaw to rotate the housing, and a hitching jaw is protrusively formed on the inclining hitching surface for restraining the rotation when the housing is rotated at a prescribed angle.

The leaf spring may be coupled to a rear surface of the connector housing to become an integral part thereof.

The connector housing may be formed at an exterior thereof with an angular surface for a tool such as a spanner or the like to be easily inserted thereon for turning, or may be formed with a hollowed groove, a through hole or a closed hole for a tool such as a driver, a rod or the like to be easily inserted thereinto for turning.

The connector plate may be formed with a plurality of protruders each radially protruding from the center thereof and formed at a prescribed angle, wherein the first hitching jaw is formed at each tip end of the protruder and the second hitching jaw is formed at each base part of the protruder.

### BRIEF DESCRIPTION OF THE DRAWINGS

For fuller understanding of the nature and objects of the present invention, reference should be made to the following detailed description taken in conjunction with the accompanying drawings in which:

FIG. 1 is an exploded perspective view of a connecting apparatus for cubicle partitioning frames according to a first embodiment of the present invention;

FIG. 2 is an assembled view of FIG. 1;

FIG. 3 is a perspective view of a connector housing of a connecting apparatus for cubicle partitioning frames as seen from the upper side according to the first embodiment of the present invention;

FIG. 4 is a perspective view of the connector housing of FIG. 3 as seen from the lower side;

FIG. 5 is a plan view of the connector housing of FIG. 3;

FIGS. 6a to 6e are cross-sectional views taken along the arrows shown in FIG. 5;

FIG. 7 is a graph that illustrates a displacement curve on a hitching surface of the connector housing in FIG. 3;

FIG. 8 is a perspective view of a holding member as seen from the lower side;

FIG. 9 is an exploded perspective view of a connector housing of a connecting apparatus for cubicle partitioning frames according to a second embodiment of the present invention;

FIG. 10 is a perspective view of a connecting plate of a connecting apparatus for cubicle partitioning frames according to a third embodiment of the present invention;

FIG. 11 is a plan view for illustrating the connecting plate of FIG. 10 installed at a cubicle partitioning frame;

FIG. 12 is a perspective view of a connecting plate at a connecting apparatus for cubicle partitioning frames according to a fourth embodiment of the present invention;

FIG. 13 is a plan view of the connecting plate of FIG. 12 installed at a cubicle partitioning frame;

FIG. 14 is a perspective view of a connecting apparatus for cubicle partitioning frames according to a fifth embodiment of the present invention;

FIG. 15 is a plan view of the connecting plate installed at the cubicle partitioning frame according to the fifth embodiment of the present invention;

FIG. 16 is a perspective view of an connecting plate of a connecting apparatus for cubicle partitioning frames according to a sixth embodiment of the present invention;

FIG. 17 is plan view of the connecting plate of FIG. 16 installed at a cubicle partitioning frame; and

FIG. 18 is a perspective view of a connecting housing of a connecting apparatus for cubicle partitioning frames according to a seventh embodiment of the present invention.

### DETAILED DESCRIPTION OF THE PREFERRED EMBODIMENTS

Hereinafter, preferred embodiments of the present invention will be described in detail with reference to the accompanying drawings.

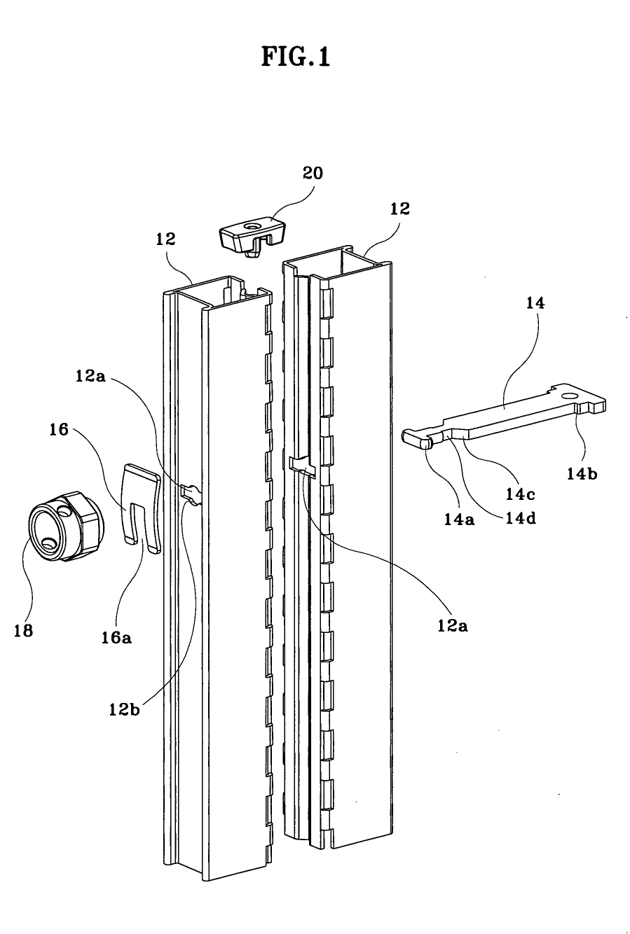

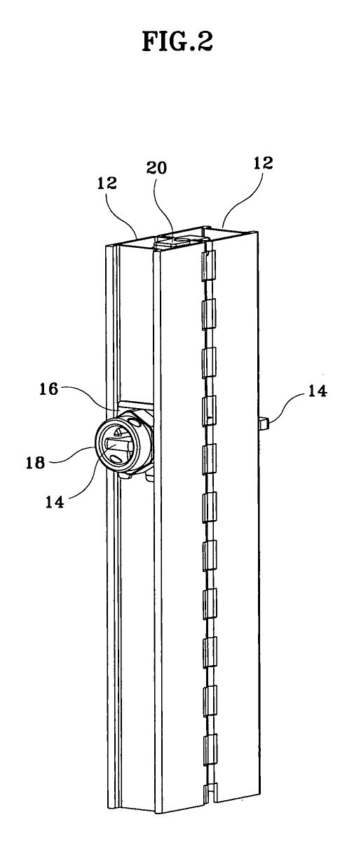

As illustrated in FIGS. 1 and 2, neighboring partitioning frames 12 are formed with connecting holes 12a and a connecting plate 14. The connecting plate 14 insertedly hitched into the connecting holes 12a. After the connecting plate 14 is inserted into the connecting holes, a leaf spring 16 is inserted onto the protruding tip portion of the connecting plate. After insertion of the leaf spring 16, a connector housing 18 is inserted onto the connecting plate 14. A holding member 20 holds the neighboring partitioning frames 12 together at the top of the frames.

The connecting hole 12a is rectangular in shape, thereby allowing the width and thickness of the connecting plate 14 to be inserted thereinto. The connecting hole 12a is centrally formed with a recess part 12b having a larger diameter of hole than width (thickness direction of the connecting plate) of the connecting hole 12a to allow bolts or the like to be fixedly inserted thereinto whenever needed.

The connecting plate 14 is formed at one end thereof with a first hitching jaw 14a that passes through the connecting hole 12a and is formed at the other end with a second hitching jaw 14b that does not pass through the connecting hole 12a. The first hitching jaw 14a is curved at an inner surface thereof (the surface contacting a hitching surface of a connector housing 18 will be described later) to allow easy rotation of the connector housing 18 and minimize friction thereof. The first hitching jaw 14a is T-shaped (wasp-waisted) at both sides for insertion into the connecting hole 12a. The wasp-waisted second hitching jaw is slanted with an incline 14c in order to prevent warpage that might occur at the partitioning frames during assembly of the cubicles. Furthermore, the wasp-waisted part bordering on the incline 14c is formed with a recess part 14d where the leaf spring 16 is insertedly hitched. The protruding portion from the partitioning frame of the second hitching jaw 12b is two-staired for prevention of stress concentration that might occur during assembly.

The leaf spring 16 which is a curved resilient plate is equipped with a deep insertion groove 16a for insertion onto the wasp-waisted part of the first hitching jaw 14a.

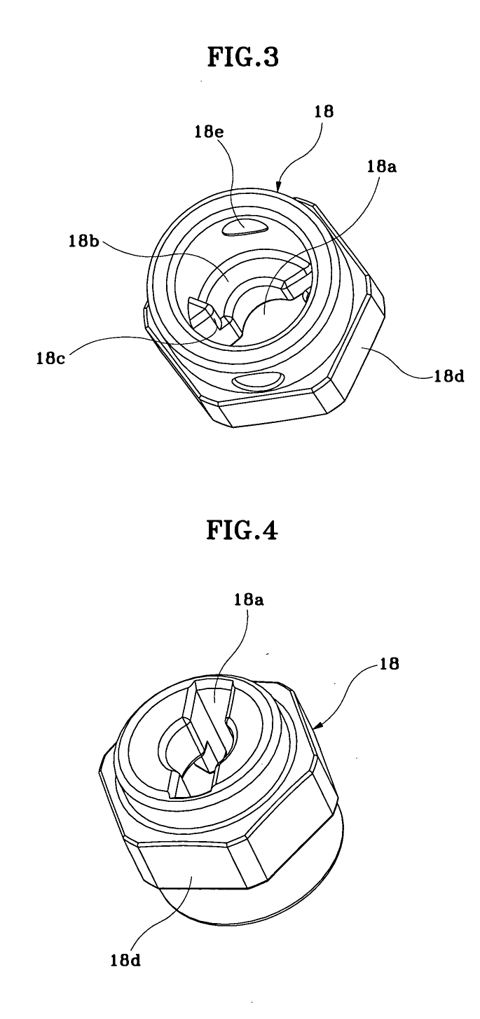

As illustrated in FIGS. 3, 4 and 5, the connector housing 18 is formed therein with an insertion hole 18a similar to the connecting hole 12a for insertion of the first hitching jaw 14a of the connecting plate 14, and is also formed with a slowly-rising-and-falling curved hitching surface 18b so as to be hitched by the first hitching jaw 14a to press the leaf spring 16 when the connector housing 18 is turned. The connector housing 18 is further formed therein with a protruding jaw 18c that protrudes from the hitching surface 18b in order to restrain the rotation when the connector housing 18 is rotated at a prescribed angle. The hitching surface 18b and the protruding jaw 18c are oppositely and symmetrically formed about the center of the insertion hole 18a.

The connector housing 18 is externally formed with a hexagonal surface 18d for a tool such as a spanner or the like to be easily inserted thereonto and turned. The connector housing 18 is also formed therein with a through hole 18e for a tool such as a driver, a rod or the like to be easily inserted thereinto and turned. It should be apparent that the connector housing 18 may be externally formed with a square surface or a pentagonal surface, and may be formed therein with a closed hole or groove other than the through hole 18e.

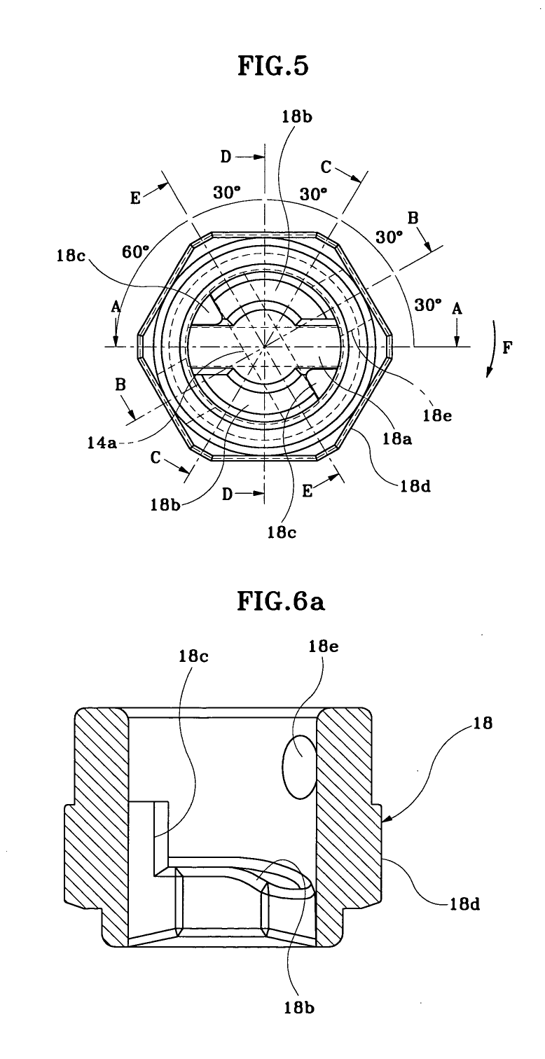

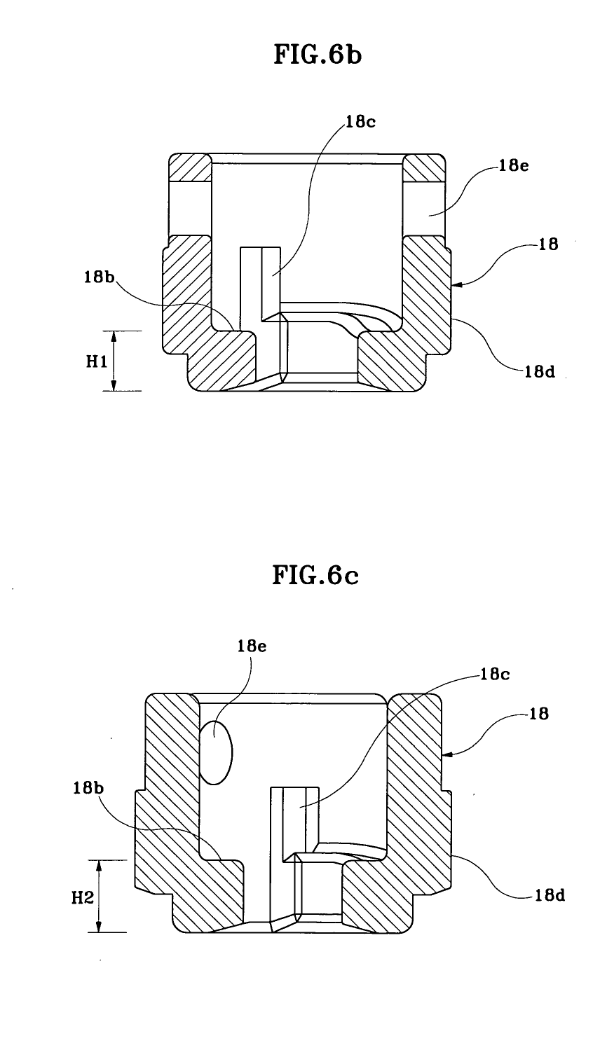

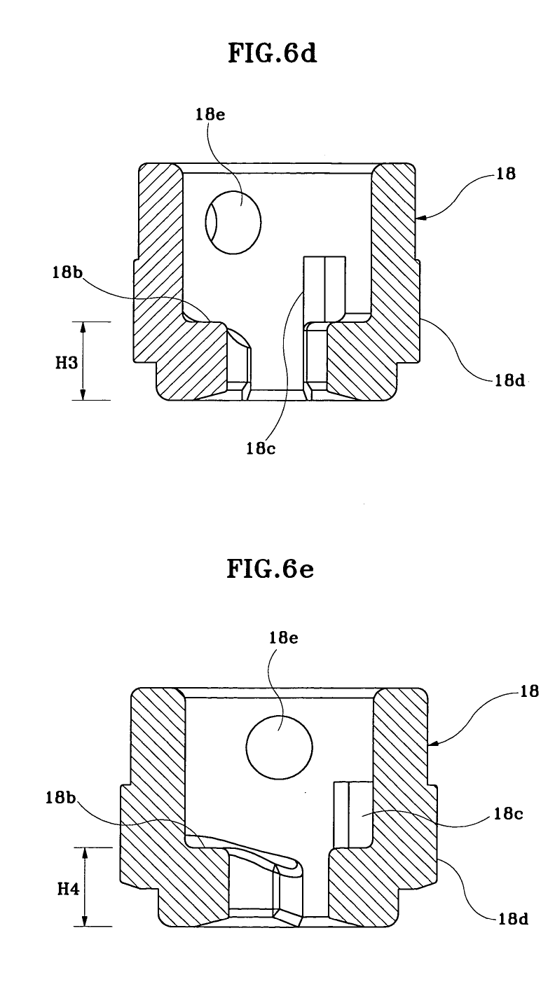

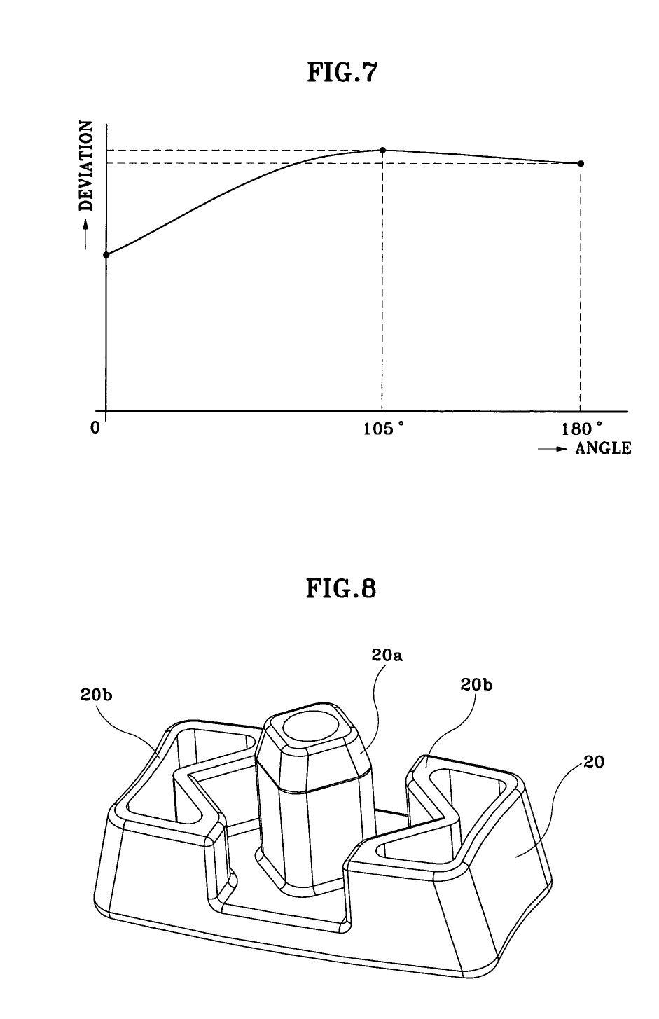

As illustrated in FIGS. 6a to 6e which are cross-sectional views seen in the directions of the arrows shown in FIG. 5, each height H1, H2, H3 and H4 from the bottom surface of the connector housing 18 gets higher and gets smaller as it goes from cross-section B-B, C-C, D-D and E-E. In other words, the curved hitching surface 18b reaches the highest point at an angle of 105 degrees, the angle being measured counterclockwise from the cross-section of A-A being referred to as zero degree, but gradually droops down as illustrated in the graph of FIG. 7.

As depicted in FIG. 8, a holding member 20 is formed at a central section of bottom surface thereof with a protruder 20a which is interposed between neighboring partitioning frames 12, and protruders 20b are disposed at both sides of the protruder 20a, each having a V-shaped entry for matching the cross-sectional profile of the partitioning frame 12. Each protruder 20b having a V-shaped entry is inserted into the partitioning frame 12 and hitched thereby.

Hereinafter, a method of connecting the partitioning frames using the connecting apparatus of partitioning frames according to the first embodiment of the present invention thus constructed will be described.

First, connecting surfaces of neighboring partitioning frames 12 that are of identical height are coupled together. The holding member 20 is then inserted onto the top of the partitioning frames to prevent separation. The holding member 20 may vary in shape thereof in relation to the cross-section of the partitioning frame 12.

Next, the first hitching jaw 14a of the connecting plate 14 is inserted into the connecting hole 12a of the partitioning frame 12 to protrude outward at the opposite side of the coupled partitioning frames 12. The second hitching jaw 14b does not pass through the connecting hole 12a and is hitched at the insertion side of the partitioning frame 12.

The groove 16a of the leaf spring 16 is inserted over the recess part 14d of the wasp-waisted part of the first hitching jaw 14a that has passed through the connecting hole 12a to protrude outward. The insertion hole 18a is inserted over the wasp-waisted part of the first hitching jaw 14a so that the bottom surface of the connector housing 18 can be abutted to the leaf spring 16. When a spanner (not shown) is inserted over the hexagonal surface 18d, or a driver or a rod is inserted into the through hole 18e to rotate the connector housing 18 clockwise (arrow F direction in FIG. 5), the first hitching jaw 14a originally positioned at a cross-section A-A in FIG. 5 relatively rides over the hitching surface 18b to be positioned on a cross-section E-E and to be restrained by the protruding jaw 18c.

At this time, the first hitching jaw 14a is made to be rotated up to 120 degrees. As shown in the graph in FIG. 7, the first hitching jaw 14a presses the hitching surface 18b up to at 105 degrees to compress the leaf spring 16. Then, the first hitching jaw 14a is retracted from 105 degrees to reach 120 degrees and the connector housing 18 is counterclockwise locked by the first hitching jaw 14a such that there is no fear of being unlocked.

The connector housing 18 may be rotated by any rod-like tool such as a driver or a rod that can be inserted into the through hole 18e, avoiding the need for a professional tool, and thus saving the installation time and cost of the cubicle.

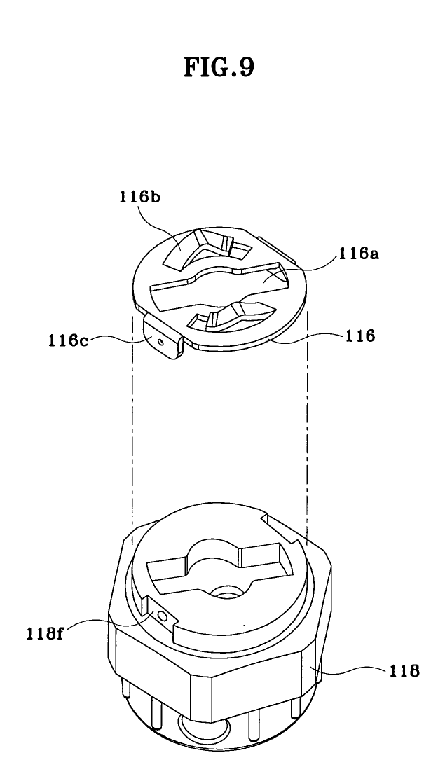

FIG. 9 is an exploded perspective view of a connector housing of a connecting apparatus of cubicle partitioning frames according to a second embodiment of the present invention. In the second embodiment, a leaf spring 116 is integrally coupled to a connector housing 118 by a pin or a fixing member (not shown).

The leaf spring 116 has a disc type shape and is centrally formed with an insertion hole 116a for a connecting plate 14 to be inserted thereinto. The insertion hole 116a is protrusively formed at both sides thereof with resilient bent pieces 116b in order to each serve as a spring. The leaf spring 116 is laterally and protrusively formed with a flange 116c in order to be fixedly inserted into a lateral surface of the connector housing 118.

The connector housing 118 is concavely formed at a lateral surface thereof with a hitching jaw 118f for the flange 116c of the leaf spring 116 to be insertedly fixed therein. The other structure of the connector housing 118 is the same as that of the first embodiment of the present invention, and the other structure of the second embodiment is also the same as that of the first embodiment of the present invention. The connector housing 118 according to the second embodiment of the present invention thus constructed is therefore very simple in assembly in that only one member needs to be inserted into the connecting plate 14.

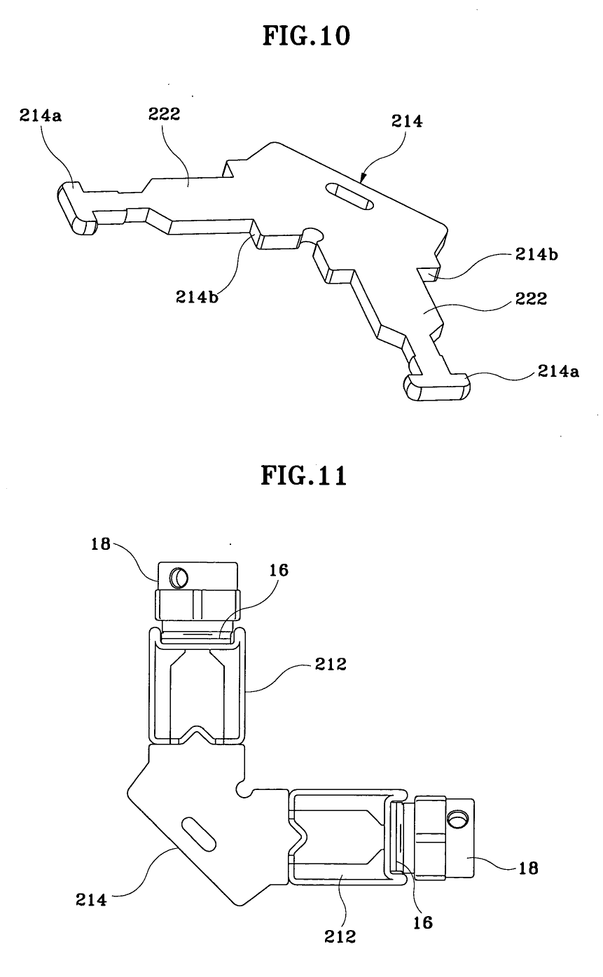

Hereinafter, a third embodiment of the present invention will be described with reference to FIG. 10. In the third embodiment, a connecting plate 214 is provided with two protruders 222 formed at a right angle in relation to the center of the connecting plate 214 and having a first hitching jaw 214a at the tip ends of the protruders 222. A second hitching jaw 214b is formed at each base part of the protruder 222. Other structures including structure of the protruder 222 at the connecting plate 214 are the same as those of the first embodiment of the present invention. In the third embodiment as shown in FIG. 11, the connecting plate 214 is used for connecting corner parts of two partitioning frames 212 that meet at a right angle.

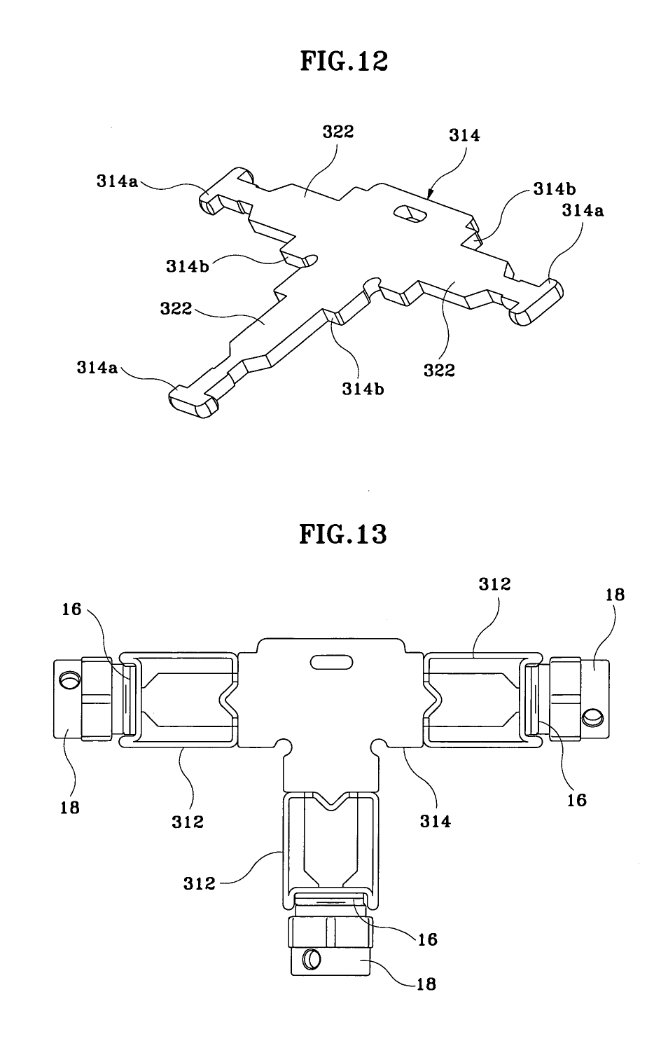

FIG. 12 is a perspective view for illustrating a connecting plate of a connecting apparatus for cubicle partitioning frames according to a fourth embodiment of the present invention, where a connecting plate 314 is provided with three protruders 222, each formed at right angles and radially protruding from the center of the connecting plate 314. A first hitching jaw 314a is formed at each tip end of the protruders 222. A second hitching jaw 314b is formed at each base part of the protruders 322. Other structure of the fourth embodiment of the present invention including that of the protruder 322 at the connecting plate 314 is the same as that of the first embodiment of the present invention. In the fourth embodiment as depicted in FIG. 13, the connecting plate 314 is used for connecting corner parts of the three partitioning frames 312, each meeting at right angles.

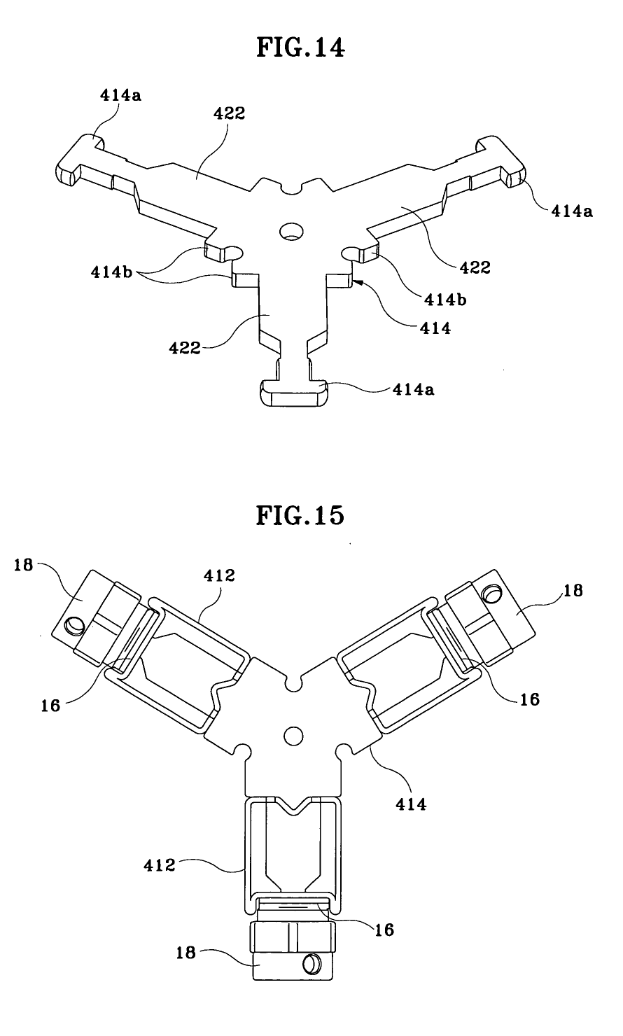

FIG. 14 is a perspective view of a connecting plate of a connecting apparatus for cubicle partitioning frames according to a fifth embodiment of the present invention. In the fifth embodiment of the present invention, a connecting plate 414 is equipped with three protruders 422, each protruder 422 centrally and radially protruding from the connecting plate 414 at 120 degrees. Each protruder 422 is formed at a tip end thereof with a first hitching jaw 414a and formed at a base part thereof with a second hitching jaw 414b. Other structures including structure of the protruder 422 at the connecting plate 414 are the same as those of the first embodiment of the present invention. The connecting plate in the fifth embodiment as shown in FIG. 15 is used for connecting corner parts of three partitioning frames 412, each meeting at 120 degrees.

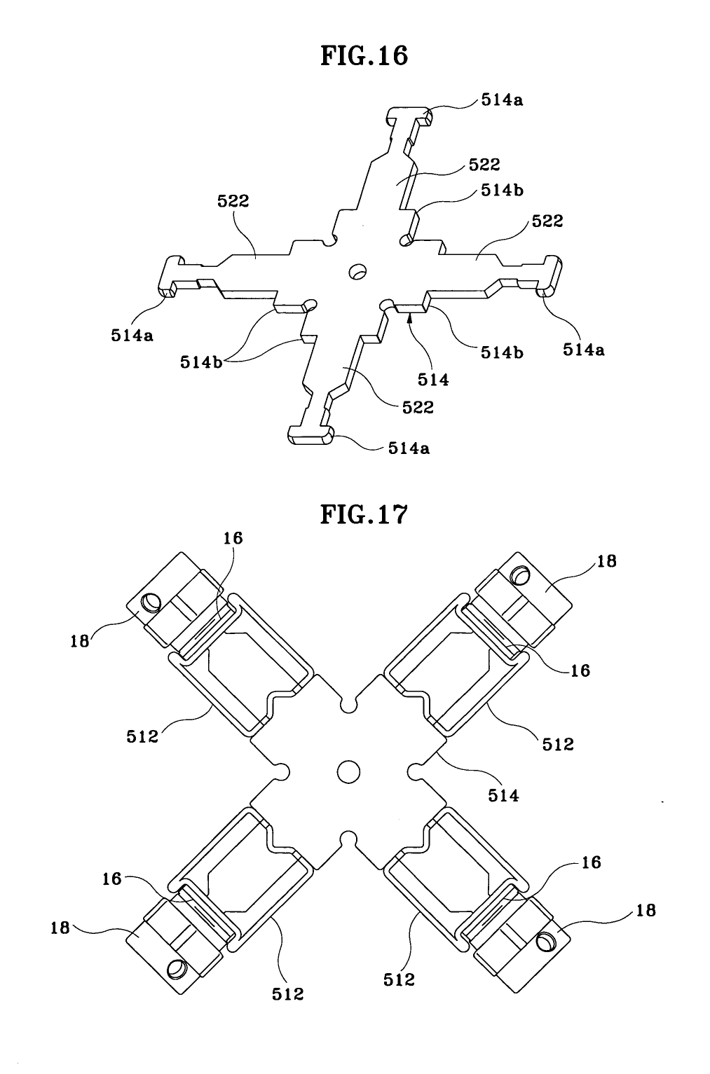

FIG. 16 is a perspective view of a connecting plate of a connecting apparatus for partitioning frames according to a sixth embodiment of the present invention. A connecting plate 514 in the sixth embodiment is provided with four protruders 522, each protruder 522 radially extended from the center of the connecting plate 514 at right angles. Each protruder 522 is formed at a tip end thereof with a first hitching jaw 514a and at the base part with a second hitching jaw 514b. Other structures including structure of the protruder 522 at the connecting plate 514 are the same as those of the first embodiment of the present invention. The connecting plate 514 in the sixth embodiment of the present invention as illustrated in FIG. 17 is used for connecting corner parts of four partitioning frames 512, each meeting at right angles.

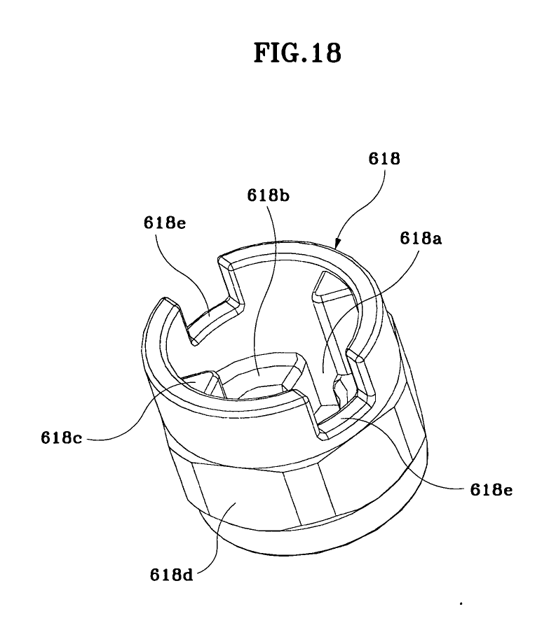

FIG. 18 is a perspective view of a connector housing 618 of a connecting apparatus for partitioning frames according to the seventh embodiment of the present invention as seen from the upper side. The connector housing 618 in the seventh embodiment of the present invention is formed with a through groove 618e so that a tool such as a driver or the like can be inserted therein for turning. The insertion hole 618, hitching surface 618b, protruding jaw 618c and hexagonal surface 618d are of the same structures as those of the connector housing 18 in the first embodiment as depicted in FIG. 3.

The foregoing description of the preferred embodiments of the present invention has been presented for the purpose of illustration and description. It is not intended to be exhaustive or to limit the invention to the precise form disclosed, and modifications and variations are possible in light of the above teachings or may be acquired from practice of the invention.

As apparent from the foregoing, there are advantages in the connecting apparatus for cubicle partitioning frames according to the embodiments of the present invention thus described in that partitioning frames can be easily and sturdily connected in a simple structure, and corner parts for connecting the partitioning frames at a prescribed angle can be also easily connected. There is another advantage in that a user can easily install the apparatus to save installation cost and time.

What is claimed is:

1. A connecting apparatus for cubicle partitioning frames, the apparatus for connecting neighboring partitioning frames each formed with connecting holes, the apparatus comprising:
a connecting plate formed at one end thereof with a first hitching jaw for insertion into and passing through said connecting hole and a second hitching jaw formed at the other end thereof for not passing through said connecting hole;
a leaf spring for being insertedly hitched by said first hitching jaw of said connecting plate; and
a connector housing for pressing said leaf spring to be insertedly hitched by said first hitching jaw of said connecting plate, wherein a slowly-rising-and-falling inclining hitching surface is formed inside said connector housing for pressing said leaf spring when hitched by said first hitching jaw to rotate said connector housing, and a hitching jaw is protrusively formed at said inclining hitching surface for restraining the rotation when said connector housing is rotated at a prescribed angle.

2. The apparatus as defined in claim 1, wherein said leaf spring is coupled to a rear surface of said connector housing to become an integral part thereof.

3. The apparatus as defined in claim 1, wherein said connector housing is formed at an exterior thereof with an angular surface for a tool such as a spanner or a rod to be easily inserted thereon for turning.

4. The apparatus as defined in claim 1, wherein said connector housing is formed with a hole for a tool such as a driver or a rod to be easily inserted thereinto for turning.

5. The apparatus as defined in claim 1, wherein said connecting plate is formed with a plurality of protruders each radially protruding from the center thereof and formed at a prescribed angle, wherein said first hitching jaw is formed at each tip end of said protruder and said second hitching jaw is formed at each base part of said protruder.
